(19) United States
(12) Patent Application Publication
(10) Pub. No.: US 2016/0316062 A1
(43) Pub. Date: Oct. 27, 2016

(54) VOICE COMMUNICATION SUPPORTING DEVICE, VOICE COMMUNICATION SUPPORTING METHOD, AND COMPUTER PROGRAM PRODUCT

(71) Applicant: KABUSHIKI KAISHA TOSHIBA, Tokyo (JP)

(72) Inventors: Shoko MIYAMORI, Kawasaki (JP); Kouji UENO, Shinagawa (JP); Tetsuro CHINO, Kawasaki (JP)

(73) Assignee: KABUSHIKI KAISHA TOSHIBA, Tokyo (JP)

(21) Appl. No.: 15/135,728

(22) Filed: Apr. 22, 2016

(30) Foreign Application Priority Data
Apr. 27, 2015 (JP) 2015-090870

(51) Int. Cl. H04M 3/533; H04M 3/537; H04M 1/725; H04M 1/02

(52) U.S. Cl. CPC H04M 3/53333; H04M 1/0258; H04M 3/537; H04M 1/72583

(57) ABSTRACT

According to an embodiment, a voice communication supporting device includes a voice receiving unit, a voice reproducing unit, a reproduction cancelling unit, and a notification sending unit. The voice receiving unit receives a voice message. The voice reproducing unit reproduces the received voice message. In response to a user operation, the reproduction cancelling unit performs control to cancel reproduction of the voice message. The notification sending unit sends, to a sender of the voice message whose reproduction has been cancelled, a cancellation notification about cancellation of reproduction of the voice message.

### CROSS-REFERENCE TO RELATED APPLICATIONS

This application is based upon and claims the benefit of priority from Japanese Patent Application No. 2015-090870, filed on Apr. 27, 2015; the entire contents of which are incorporated herein by reference.

### FIELD

Embodiments described herein relate generally to a voice communication supporting device, a voice communication supporting method, and a computer program product.

### BACKGROUND

Regarding communication of information by means of utterance and audition of voice, since those actions rarely interrupt the other behavior, such a method of communication has a high degree of usefulness as the method of sharing information among people who are particularly performing some tasks. In recent years, a technology has been proposed for supporting information sharing by means of utterance and audition of voice (hereinafter, called “voice communication”). For example, during the voice communication performed by users who are engaged in nursery care/elderly care; each user is made to wear a headset connected to a handheld terminal, and a voice uttered by one user is delivered as a voice message to the handheld terminals of the other users and is reproduced in those handheld terminals. As a result, the users who receive the voice message can listen to the voice message through the headset they are wearing, and can get the information without having to voluntarily perform operations to obtain the information.

However, in this case, a voice message is auto-reproduced in the handheld terminals of the users who receive the voice message. Hence, each user has to listen to the voice message that may be redundant to him or her. Moreover, listening to a voice message on the receiver side obstructs the transmission of a new voice message from the receiver side. For that reason, there is a demand for a mechanism that enables a user to intentionally cancel the reproduction of a voice message. However, regarding a voice message that is cancelled by a user because he or she determines it to be unnecessary, there are times when information necessary for that user is actually included in the cancelled voice message. Furthermore, there are times when a user mistakenly cancels the reproduction of a voice message. Hence, while building a mechanism that enables a user to intentionally cancel the reproduction of voice messages, in case the reproduction of a voice message that needed to be listened to is cancelled, it is necessary to take into account the countermeasure to prevent the user from missing out on listening to the concerned voice message.

### BRIEF DESCRIPTION OF THE DRAWINGS

FIG. 1 is a schematic diagram illustrating an outline of the system assumed in the embodiments;

FIG. 2 is a diagram illustrating an example of the headset;

FIG. 3 is a diagram illustrating another example of the headset;

FIG. 4 is a block diagram illustrating a configuration of the voice communication supporting device according to a first embodiment;

FIG. 5 is a flowchart for explaining the basic operations performed by the voice communication supporting device;

FIG. 6 is a block diagram illustrating a configuration of the voice communication supporting device according to a second embodiment;

FIG. 7 is a flowchart for explaining an exemplary sequence of operations performed by the voice message managing unit;

FIG. 8 is a diagram for explaining the conditions for reproducing a voice message, whose reproduction has been cancelled, for the second time;

FIG. 9 is a block diagram illustrating such a modification example of the second embodiment;

FIG. 10 is a block diagram illustrating a voice communication supporting device according to a third embodiment;

FIG. 11 is a block diagram illustrating a configuration example of the voice communication supporting device according to a fourth embodiment;

FIG. 12 is a diagram illustrating an example of the message list screen; and

FIG. 13 is a block diagram illustrating an exemplary hardware configuration of the voice communication supporting device according to the embodiments.

### DETAILED DESCRIPTION

According to an embodiment, a voice communication supporting device includes a voice receiving unit, a voice reproducing unit, a reproduction cancelling unit, and a notification sending unit. The voice receiving unit receives a voice message. The voice reproducing unit reproduces the received voice message. In response to a user operation, the reproduction cancelling unit performs control to cancel reproduction of the voice message. The notification sending unit sends, to a sender of the voice message whose reproduction has been cancelled, a cancellation notification about cancellation of reproduction of the voice message.

Embodiments of a voice communication supporting device, a voice communication supporting method, and a computer program product are described below in detail with reference to the accompanying drawings. The embodiments explained below are assumed to be implemented in a terminal that is meant for providing services as disclosed in Literature 1 or Literature 2.

Literature 1: Press release from Japan Advanced Institute of Science and Technology, “Professor Uchihira et al. of School of Knowledge Science, JAIST develop a system by which only “murmuring” into a smartphone intended for healthcare services enables visualization by means of sharing of records/communication/information and log analysis”, [online], Oct. 31, 2013, [searched on Apr. 15, 2015], Internet <URL: http://www.jaist.ac.jp/news/press/2013/post-380.html>

Literature 2: Torii Kentaro, “SNS for home healthcare enabling registration by voice at anytime and anywhere”, [online], Sep. 12, 2014, [searched on Apr. 15, 2015], Internet <URL:

http://www.chubu.meti.go.jp/technology_jyoho/download/2014091 2/20140912toshiba.pdf>

However, the implementable embodiments are not limited to those examples. For example, even if the configuration is such that voice messages are sent and received directly among terminals (without using a server in between); the voice communication supporting device, and a voice communication supporting method, and a computer program product can be implemented in an effective manner.

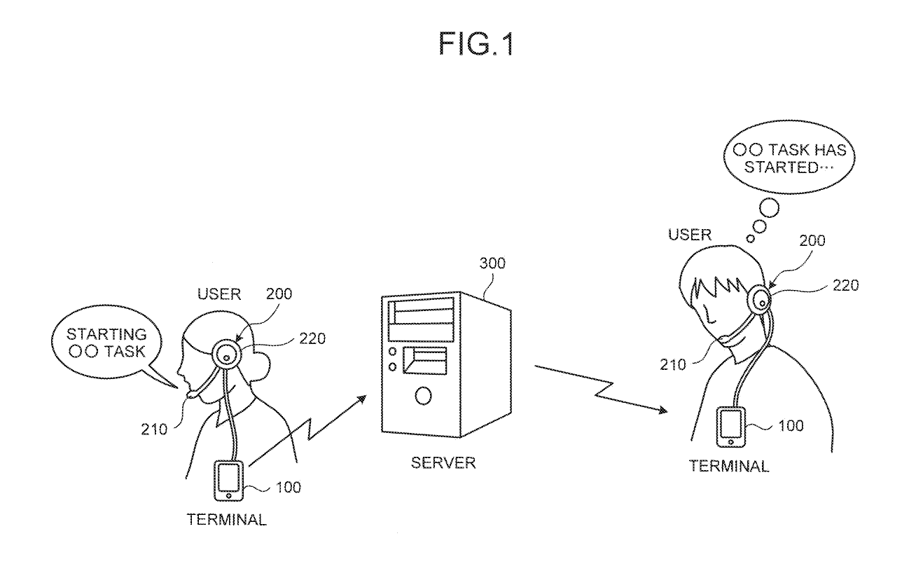

To start with, explained with reference to FIG. 1 is a brief overview of a system assumed in the embodiments. FIG. 1 is a schematic diagram illustrating an outline of the system assumed in the embodiments. As illustrated in FIG. 1, each user who is a recipient of the service provided by the system carries a terminal 100 such as a smartphone, and performs various tasks while wearing a headset 200 connected to the terminal 100. When a user utters a message related to a task or utters what he or she has noticed during a task, the utterance is recorded by a microphone 210 of the headset 200 and is sent as a voice message to a server 300. Upon receiving the voice message from the terminal 100, the server 300 performs voice recognition with respect to the voice message; analyzes sensor data that is sent separately by the terminal 100; auto-generates metadata related to the received voice message; and stores the voice message along with the metadata.

Moreover, the server 300 refers to the metadata of the stored voice messages, refers to pre-registered information related to the tasks of each user, and refers to sensor data sent separately from the terminal 100 of each user; and determines the destination and the delivery timing for each stored voice message. Then, the server 300 delivers each stored voice message at an appropriate timing to the terminal 100 of other users who are determined as the destinations. At that time, a voice message determined to be urgent is delivered immediately (almost in real time). The terminal 100 of each other user who receives the voice message auto-reproduces the received voice message regardless of the task of that user, so that the voice message is output from a speaker 220 of the headset 200. As a result, the other users can listen to the voice message without having to voluntarily perform operations to obtain the information and can share the information with the user who sent it.

The voice communication supporting device according to the embodiments is implemented as, for example, the terminal 100 illustrated in FIG. 1. In this case, the terminal 100 not only has the basic functions of sending voice messages and receiving and reproducing voice messages, but also has the function of cancelling the reproduction of a received voice message in response to a user operation and the function of sending a cancellation notification about cancellation of the reproduction of the concerned voice message to the terminal 100 that sent the voice message. Herein, the cancellation notification may be sent to the source terminal 100 of the voice message via the server 300, or the cancellation notification may be directly sent to the source terminal 100 of the voice message (without using the server 300 in between). The various functions of the terminal 100 can be implemented, for example, when a dedicated application program for receiving the services of the system is installed in the terminal 100, and is then executed by the terminal 100.

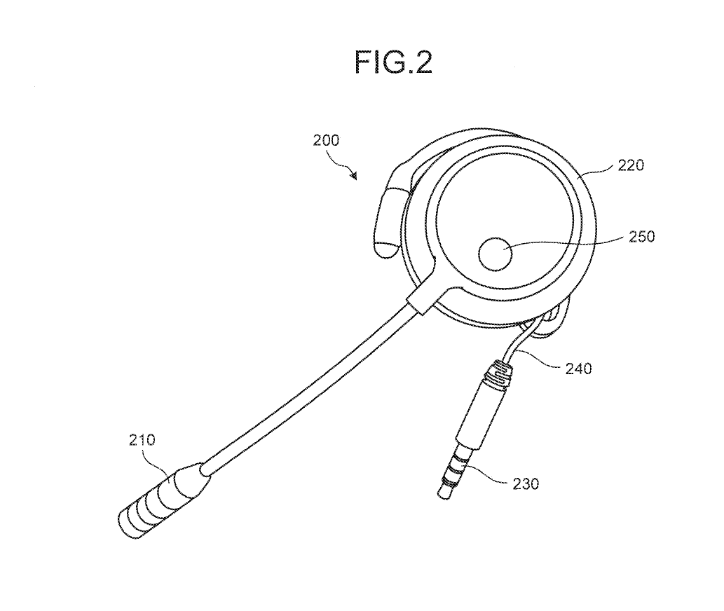

Given below is the explanation of a specific example of the headset 200 that is worn by a user. FIG. 2 is a diagram illustrating an example of the headset 200. Herein, the headset 200 illustrated in FIG. 2 can be used by plugging a phone plug 230 thereof into a phone jack of the terminal 100. A cable 240, which has the phone plug 230 disposed at the leading end thereof, is retractable inside the housing of the speaker 220. The microphone 210 is integrated with the housing of the speaker 220.

On the housing of the speaker 220, an operation button 250 is disposed at an easy-to-operate position for the user. The operation button 250 is operated by the user when the reproduction of a voice message is to be cancelled or when the recording of an utterance is to be started/ended. That is, if the user presses the operation button 250 while the terminal 100 is reproducing a received voice message, the reproduction of that voice message gets cancelled. Moreover, if the user presses the operation button 250 when no voice message is being reproduced, the recording of an utterance is started. When the user presses the operation button 250 again, the recording of the utterance is ended.

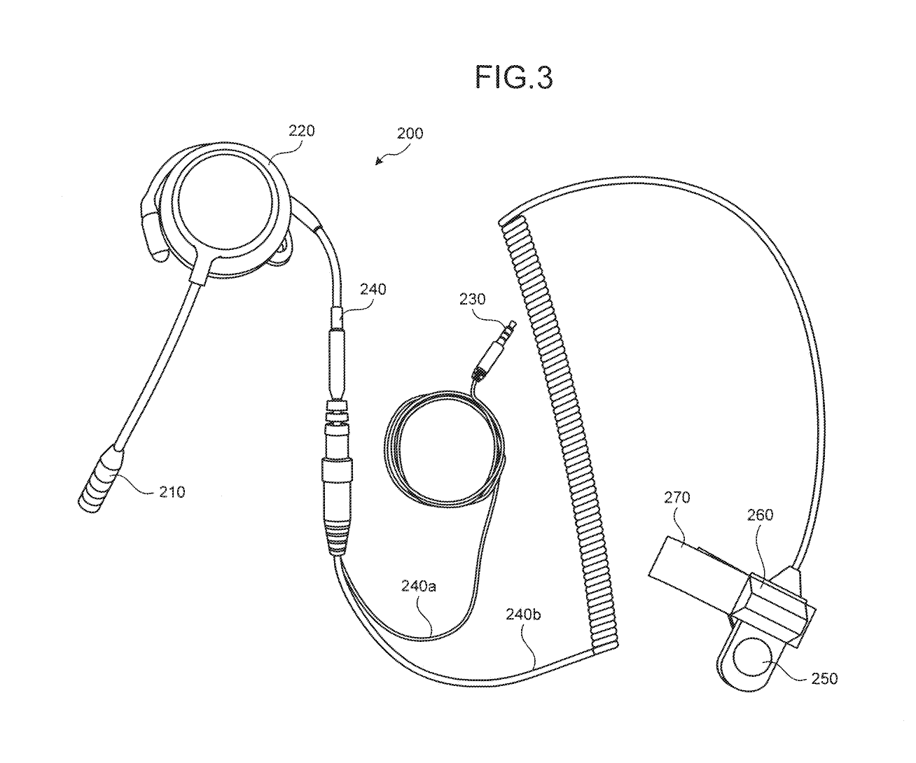

FIG. 3 is a diagram illustrating another example of the headset 200. In the headset 200 illustrated in FIG. 3, the operation button 250 is distantly positioned from the housing of the speaker 220. Thus, in the headset 200 illustrated in FIG. 3, the cable 240 branches off along the way into a cable 240a, which has the phone plug 230 disposed at the leading end thereof, and a cable 240b, which has a button holder 260 disposed at the leading end thereof. The operation button 250 is disposed inside the button holder 260. Moreover, the button holder 260 has a fitting 270 that enables a user to wear the button holder 260 on an arm. Meanwhile, the configurations of the headset 200 illustrated in FIGS. 2 and 3 are only exemplary, and the configuration is not limited to those examples.

Given below is the explanation of a specific example of the voice communication supporting device according to the embodiments that is assumed to be implemented as the terminal 100. Thus, in the following example, along with the terminal 100, the voice communication supporting device according to the embodiments is also referred to by the same reference numeral. Moreover, in the embodiments described above, the same or corresponding constituent elements are referred to by the same reference numerals. The voice communication supporting device 100 has the function of a transmitter that obtains an utterance of the user and sends the utterance as a voice message, as well as has the function of a receiver that receives and reproduces a voice message. Alternatively, the voice communication supporting device 100 can have either the function of a transmitter only or the function of a receiver only. Moreover, it is assumed that the voice communication supporting device 100 performs transmission and reception of voice messages and cancellation notifications with other voice communication supporting devices 100 via the server 300. Alternatively, the voice communication supporting device 100 can be configured to perform transmission and reception of voice messages and cancellation notifications directly with other voice communication supporting devices 100 (without using the server 300 in between).

### First Embodiment

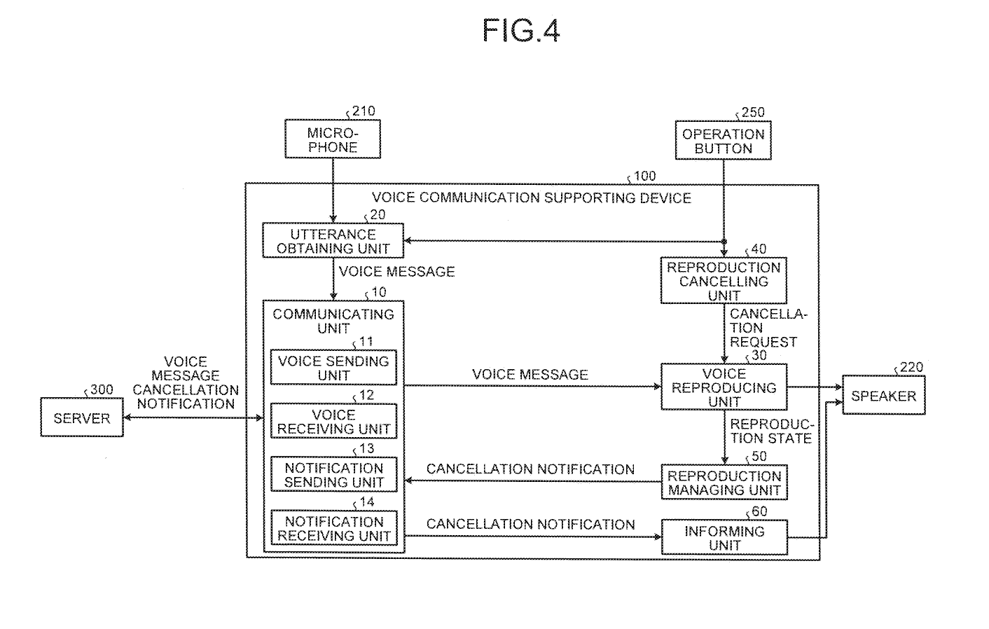

FIG. 4 is a block diagram illustrating a configuration of the voice communication supporting device 100 according to a first embodiment. As illustrated in FIG. 4, the voice communication supporting device 100 according to the first embodiment includes a communicating unit 10, an utterance obtaining unit 20, a voice reproducing unit 30, a reproduction cancelling unit 40, a reproduction managing unit 50, and an informing unit 60.

The communicating unit 10 is a module for performing communication with the outside (for example, with the server 300) via a network. The communicating unit 10 includes, as submodules, a voice sending unit 11 that sends voice messages to the outside; a voice receiving unit 12 that receives voice messages from the outside; a notification sending unit 13 that sends to the outside a cancellation notification about cancellation of the reproduction of a voice message; and a notification receiving unit 14 that receives a cancellation notification from the outside.

The utterance obtaining unit 20 is a module for obtaining an utterance of the user through the microphone 210. For example, while no voice message is being reproduced by the voice reproducing unit 30, if the user presses the operation button 250, the utterance obtaining unit 20 starts obtaining an utterance. After that, when the user presses the operation button 250 again, the utterance obtaining unit 20 ends obtaining the utterance. Then, the voice sending unit 11 of the communicating unit 10 sends the user utterance, which is obtained by the utterance obtaining unit 20, as a voice message to the outside.

The voice reproducing unit 30 is a module for reproducing a voice message, which is received by the voice receiving unit 12 of the communicating unit 10, and outputting the reproduced voice message from the speaker 220 regardless of the user operations. In the first embodiment, a voice message received by the voice receiving unit 12 is reproduced immediately by the voice reproducing unit 30, and the user need not perform any operations in order to reproduce the voice message. Thus, without having to explicitly perform any operation to obtain information, the user can listen to the voice message, which is sent from another voice communication supporting device 100 via, for example, the server 300, through the speaker 220.

The reproduction cancelling unit 40 is a module for performing control in such a way that the reproduction of a voice message performed by the voice reproducing unit 30 is cancelled in response to a user operation. For example, while the voice reproducing unit 30 is reproducing a voice message, if the user presses the operation button 250, the reproduction cancelling unit 40 issues a cancellation request to the voice reproducing unit 30 to cancel (stop) the reproduction of the voice message. In the first embodiment, since the reproduction cancelling unit 40 is provided, it becomes possible for the user to intentionally cancel the reproduction of a voice message that is sent from another voice communication supporting device 100 via, for example, the server 300.

The reproduction managing unit 50 is a module for managing the state of reproduction of a voice message that is subjected to reproduction by the voice reproducing unit 30. For example, the reproduction managing unit 50 monitors the state of reproduction of a voice message that is subjected to reproduction by the voice reproducing unit 30, and determines whether or not the reproduction of the voice message received by the voice receiving unit 12 has been completed. If the voice reproducing unit 30 cancels (stops) the reproduction of the voice message in response to a cancellation request issued by the reproduction cancelling unit 40, the reproduction managing unit 50 detects cancellation of the reproduction of the voice message and sends a cancellation notification about cancellation of the reproduction of the voice message to the notification sending unit 13 of the communicating unit 10. Then, the notification sending unit 13 sends the cancellation notification to the other voice communication supporting device 100, which had sent the voice message whose reproduction is cancelled, via the server 300, for example. Meanwhile, in the first embodiment, the reproduction managing unit 50 issues a cancellation notification. Alternatively, the reproduction cancelling unit 40 may issue a cancellation notification at a time when the reproduction cancelling unit 40 issues a cancellation request to the voice reproducing unit 30 as well as send the cancellation notification to the notification sending unit 13 of the communicating unit 10.

The informing unit 60 is a module for informing the user that the reproduction of the voice message, which the user had uttered, was cancelled at the receiver side. The informing unit 60 receives a cancellation notification that was received by the notification receiving unit 14 of the communicating unit 10 and, for example, performs an audio output from the speaker 220 to inform the user that the reproduction of the sent voice message was cancelled at the receiver side. At that time, the cancellation notification received by the notification receiving unit 14 may include information about the user who received the voice message but cancelled the reproduction of the voice message. With this, the informing unit 60 can output a voice, such as “the user XYZ cancelled the reproduction”, from the speaker 220 thereby enabling identification of the other user who cancelled the notification, and can make the user who sent the voice message know that the information has not reached the other user.

If the voice message whose reproduction is cancelled by the other user represents information that should be listened to by the other user, the user who is informed by the informing unit 60 can take a measure such as uttering the message again so that a voice message is newly sent. If the information is of particular urgency, the user who is informed by the informing unit 60 can take a measure such as going off to directly talk to the other user. As a result, it becomes possible to reduce the risk that the user on the receiver side cancels the reproduction of a voice message and thus misses out on listening to the voice message that needs to be listened to.

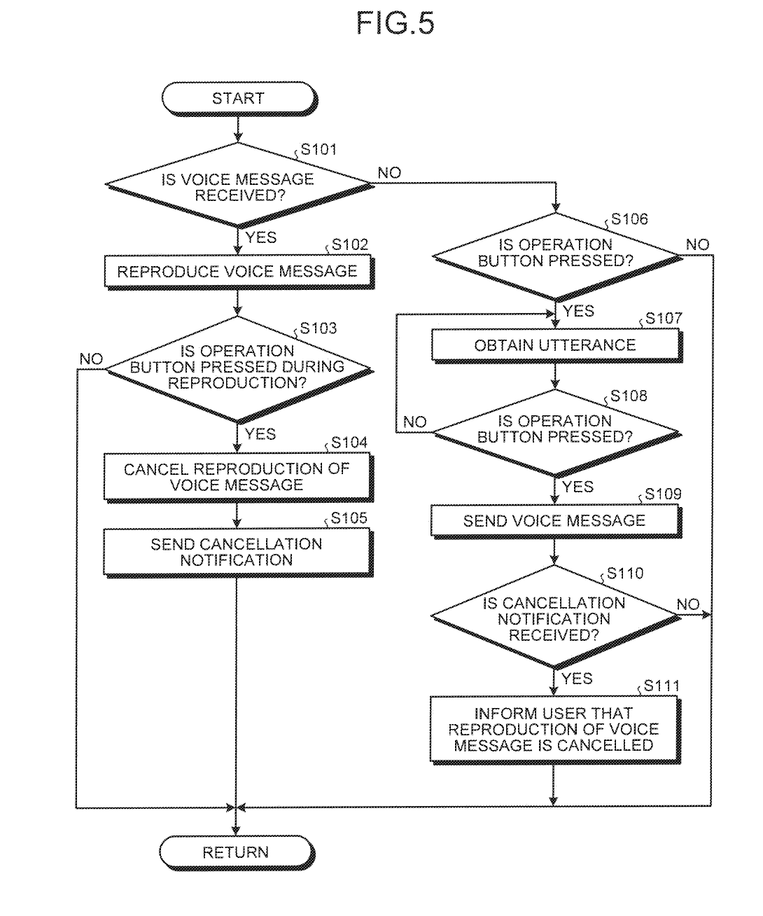

Explained below with reference to FIG. 5 is the general description of the operations performed by the voice communication supporting device 100 according to the first embodiment. FIG. 5 is a flowchart for explaining the basic operations performed by the voice communication supporting device 100 according to the first embodiment, and represents a sequence of operations performed in a repeated manner.

When the voice receiving unit 12 receives a voice message (Yes at Step S101), the voice reproducing unit 30 reproduces the voice message received by the voice receiving unit 12 (Step S102). While the voice reproducing unit 30 is reproducing the voice message, the reproduction cancelling unit 40 monitors whether or not the operation button 250 is operated by the user. If the operation button 250 is operated during the reproduction of the voice message (Yes at Step S103), then the reproduction cancelling unit 40 issues a cancellation request to the voice reproducing unit 30 so as to cancel the reproduction of the voice message (Step S104). When the reproduction of the voice message is cancelled, the reproduction managing unit 50 detects the cancellation and sends a cancellation notification about cancellation of the reproduction of the voice message to the notification sending unit 13 of the communicating unit 10. Then, the notification sending unit 13 sends the cancellation notification to the other voice communication supporting device 100, which had sent the voice message whose reproduction is cancelled, via the server 300, for example, (Step S105).

Meanwhile, when the voice reproducing unit 30 is not reproducing any voice message, that is, when the voice receiving unit 12 has not received any voice message (No at Step S101), the utterance obtaining unit 20 monitors whether or not the operation button 250 is operated by the user. If the operation button 250 is pressed while no voice message is being reproduced (Yes at Step S106), the utterance obtaining unit 20 starts obtaining an utterance of the user (Step S107). Herein, the utterance obtaining unit 20 continually obtains the utterance until the operation button 250 is pressed again (No at Step S108, Step S107). When the operation button 250 is pressed again (Yes at Step S108), the utterance obtaining unit 20 ends obtaining the utterance, and the voice sending unit 11 sends the utterance of the user, which is obtained by the utterance obtaining unit 20, as a voice message (Step S109). Subsequently, when the notification receiving unit 14 receives a cancellation request (Yes at Step S110), the informing unit 60 informs the user that the reproduction of the voice message, which was sent by the voice sending unit 11, has been cancelled at the receiver side (Step S111).

As described above, according to the first embodiment, in the voice communication supporting device 100 on the receiver side, when the operation button 250 is pressed during the reproduction of a received voice message, the reproduction of the voice message is cancelled and a cancellation notification about cancellation of the reproduction of the voice message is sent to the voice communication supporting device 100 on the sender side. Then, in the voice communication supporting device 100 on the sender side, the user is informed about cancellation of the reproduction of the sent voice message at the receiver side. Thus, according to the first embodiment, while enabling a user to intentionally cancel the reproduction of a voice message, it becomes possible to effectively prevent the user from missing out on listening to the necessary voice messages.

In the explanation given above, an operation of the operation button 250 is explained as an example of the user operation for cancelling the reproduction of a voice message. However, the user operation for cancelling the reproduction of a voice message is not limited to that example. Alternatively, for example, the configuration can be such that a button is displayed on a touch-sensitive panel display and, when that button is touched, the reproduction of a voice message is cancelled. Still alternatively, the configuration can be such that the utterances of the user are subjected to voice recognition and, when a predetermined command is recognized, the reproduction of a voice message is cancelled.

In the explanation given above, a voice output performed from the speaker 220 is explained as an exemplary method by which the informing unit 60 informs the user about cancellation of the reproduction of the voice message at the receiver side. However, the method for informing the user is not limited to that example. Alternatively, for example, the configuration can be such that a character string or a symbol indicating cancellation of the reproduction of the voice message is displayed on a display so as to inform the user about the same.

In the explanation given above, the reproduction of a received voice message is cancelled (stopped) when the operation button 250 is pressed during the reproduction of the voice message. However, that is not the only possible case. Alternatively, for example, the configuration can be such that a setting for cancelling the reproduction of voice messages is performed in response to a user operation before receiving any voice message and, until the setting is released, the reproduction of any received voice message is cancelled.

### Second Embodiment

Given below is the explanation of a second embodiment. In the second embodiment, the configuration is such that, when a predetermined condition is satisfied, a voice message whose reproduction has been cancelled is reproduced again at a predetermined timing.

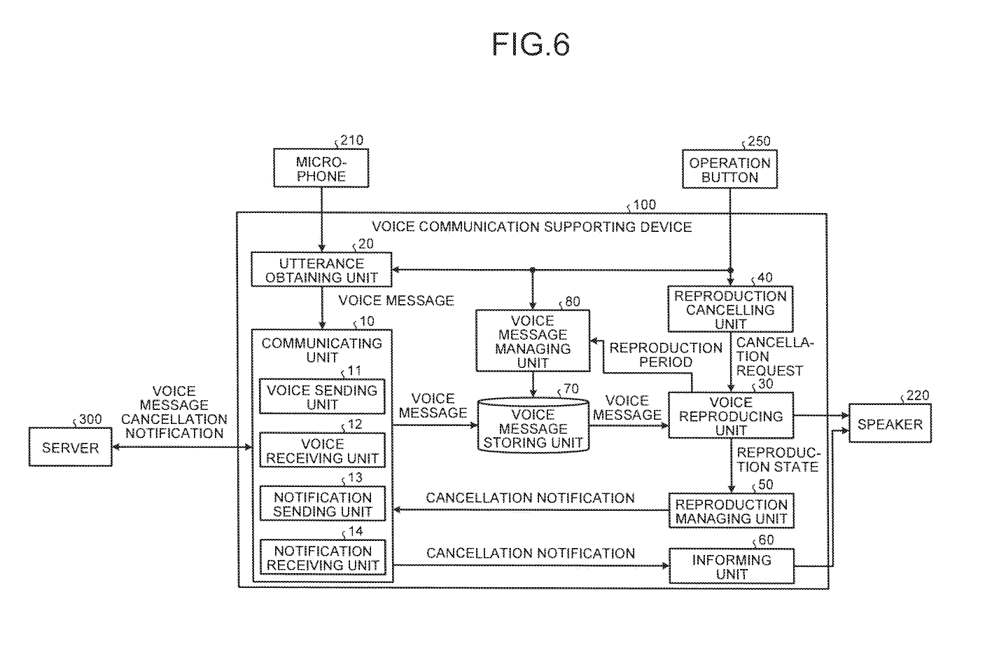

FIG. 6 is a block diagram illustrating a configuration of the voice communication supporting device 100 according to the second embodiment. As illustrated in FIG. 6, the voice communication supporting device 100 according to the second embodiment includes a voice message storing unit 70 and a voice message managing unit 80 in addition to having the configuration according to the first embodiment (see FIG. 4). The following explanation is given only about the differences with the first embodiment.

The voice message storing unit 70 is a voice buffer for temporarily storing the voice messages received by the voice receiving unit 12. In the second embodiment, each voice message stored in the voice message storing unit 70 is sent to the voice reproducing unit 30 as needed, and is reproduced by the voice reproducing unit 30. When reproduction of a voice message is completed, the reproduction managing unit 50 or the voice reproducing unit 30 deletes the voice message from the voice message storing unit 70.

The voice message managing unit 80 is a module for determining whether or not a voice message whose reproduction has been cancelled is to be reproduced again. In the second embodiment, since the voice message whose reproduction has been cancelled is stored in the voice message storing unit 70, it is possible to reproduce the voice message again later. However, if the user listens to some part of the voice message before cancelling the reproduction of the voice message, it is assumed that the user has confirmed the voice message to be unnecessary before cancelling the reproduction of the voice message. Hence, it is not desirable to reproduce the voice message again, as it would lead to botheration. On the other hand, if the user cancels the reproduction of a received voice message for the purpose of sending a voice message or if the user cancels the reproduction of a voice message due to a wrong operation, it is beneficial to reproduce the concerned voice message again later. In that regard, in the second embodiment, the voice message managing unit 80 determines, based on the period of reproduction of the voice message whose reproduction has been cancelled and based on the timing of operation of the operation button 250, whether or not to reproduce the voice message, whose reproduction has been cancelled, for the second time.

More particularly, for example, when the voice reproducing unit 30 cancels the reproduction of a voice message in response to a cancellation request from the reproduction cancelling unit 40, the voice message managing unit 80 obtains the period of reproduction of the voice message up to the cancellation of reproduction from the voice reproducing unit 30. Moreover, the voice message managing unit 80 monitors whether or not the user has operated the operation button 250. Then, if the period of reproduction of the voice message whose reproduction has been cancelled is shorter than a predetermined threshold value and if the period of time from pressing of the operation button 250 during the reproduction of the voice message (i.e., pressing of the operation button 250 for the purpose of cancelling the reproduction of the voice message) to re-pressing of the operation button 250 is shorter than a predetermined second threshold value, the voice message managing unit 80 determines that the voice message needs to be reproduced again.

When it is determined that the voice message whose reproduction has been cancelled needs to be reproduced again, the voice message managing unit 80 attaches, for example, a repeat flag to the voice message stored in the voice message storing unit 70. The repeat flag represents information enabling identification of a voice message that needs to be reproduced again. Thus, the voice message that has the repeat flag attached thereto by the voice message managing unit 80 is retrieved from the voice message storing unit 70 at a predetermined timing, and is reproduced again by the voice reproducing unit 30. Examples of the predetermined timing include the timing at which the utterance obtaining unit 20 finishes obtaining an utterance of the user, or the timing after a predetermined elapsed time since the first time of cancellation of the reproduction, or the timing at which a predetermined user operation is performed to request repeated reproduction of the voice message. Meanwhile, if it is determined that the voice message whose reproduction has been cancelled need not be reproduced again, then the voice message managing unit 80 deletes the voice message from the voice message storing unit 70.

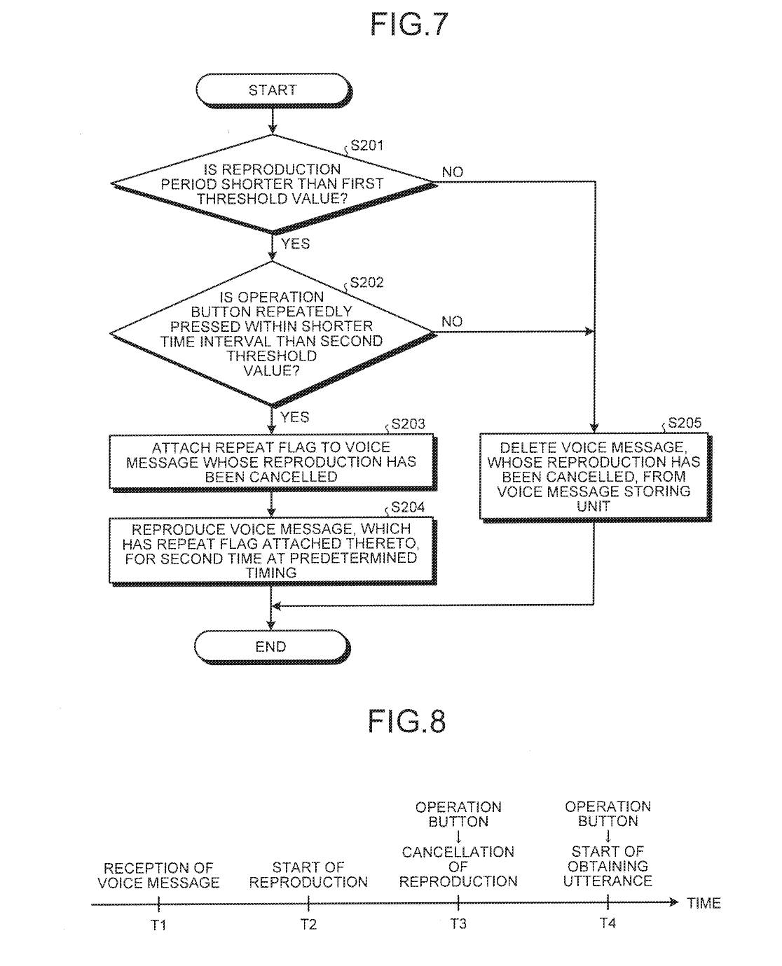

FIG. 7 is a flowchart for explaining an exemplary sequence of operations performed by the voice message managing unit 80. When the reproduction of a voice message is cancelled, the voice message managing unit 80 obtains, from the voice reproducing unit 30, the period of reproduction of the voice message whose reproduction has been cancelled and determines whether or not the period of reproduction is shorter than the first threshold value (Step S201). If the period of reproduction of the voice message whose reproduction has been cancelled is shorter than the first threshold value (Yes at Step S201), the voice message managing unit 80 further determines whether or not the operation button 250 is pressed again within a shorter time interval than the second threshold value (Step S202). If the operation button 250 is pressed again within a shorter time interval than the second threshold value (Yes at Step S202), the voice message managing unit 80 attaches a repeat flag to the voice message stored in the voice message storing unit 70 (Step S203). The voice message that has the repeat flag attached thereto is retrieved from the voice message storing unit 70 at a predetermined timing, and is reproduced again by the voice reproducing unit 30 (Step S204). Meanwhile, if the period of reproduction of the voice message whose reproduction has been cancelled is equal to or longer than the first threshold value (No at Step S201), or if the operation button 250 is either not pressed again or is pressed again within a time interval equal to or longer than the second threshold value (No at Step S202), the voice message managing unit 80 deletes the voice message, whose reproduction has been cancelled, from the voice message storing unit 70 (Step S205).

FIG. 8 is a diagram for explaining the conditions for reproducing a voice message, whose reproduction has been cancelled, for the second time. Assume that T1 represents the timing at which the voice receiving unit 12 receives a voice message; T2 represents the timing at which the voice reproducing unit 30 starts reproducing the voice message; T3 represents the timing at which the reproduction of the voice message is cancelled in response to the pressing of the operation button 250; and T4 represents the timing at which the utterance obtaining unit 20 starts obtaining the user utterance in response to the pressing of the operation button 250. If the period of time from the timing T2 to the timing T3 is shorter than the first threshold value and if the period of time from the timing T3 to the timing T4 is shorter than the second threshold value, then the voice message whose reproduction is cancelled is reproduced again at a predetermined timing.

As described above, in the second embodiment, it is determined whether or not a voice message whose reproduction has been cancelled needs to be reproduced again, and the necessary voice messages are reproduced again at predetermined timings. Hence, it becomes possible to more effectively prevent a situation of missing out on listening to the voice messages that need to be listened to.

Meanwhile, in the explanation given above, the condition for reproducing a voice message, whose reproduction has been cancelled, for the second time is that the period of reproduction is shorter than the first threshold value and the operation button 250 is pressed again within a shorter time interval than the second threshold value. However, that is not the only possible case. Alternatively, for example, when the period of reproduction is shorter than the first threshold value, regardless of whether or not the operation button 250 is pressed again within a shorter time interval than the second threshold value, the voice message whose reproduction has been cancelled is reproduced again at a predetermined timing.

In the explanation given above, a voice message that is determined not necessary to be reproduced again is deleted from the voice message storing unit 70; while a voice message that is determined necessary to be reproduced again is not deleted from the voice message storing unit 70 but is attached with a repeat flag and is reproduced again at a predetermined timing. However, that is not the only possible case. Alternatively, for example, regardless of the need to reproduce a voice message again, any voice message whose reproduction has been started once is deleted from the voice message storing unit 70; and a voice message determined necessary to be reproduced again is obtained by the voice message managing unit 80 from the voice reproducing unit 30 and is newly stored in the voice message storing unit 70. In that case, the voice message that is newly stored in the voice message storing unit 70 can be the un-reproduced portion of the voice message whose reproduction was cancelled or can be the entire voice message including the already-reproduced portion.

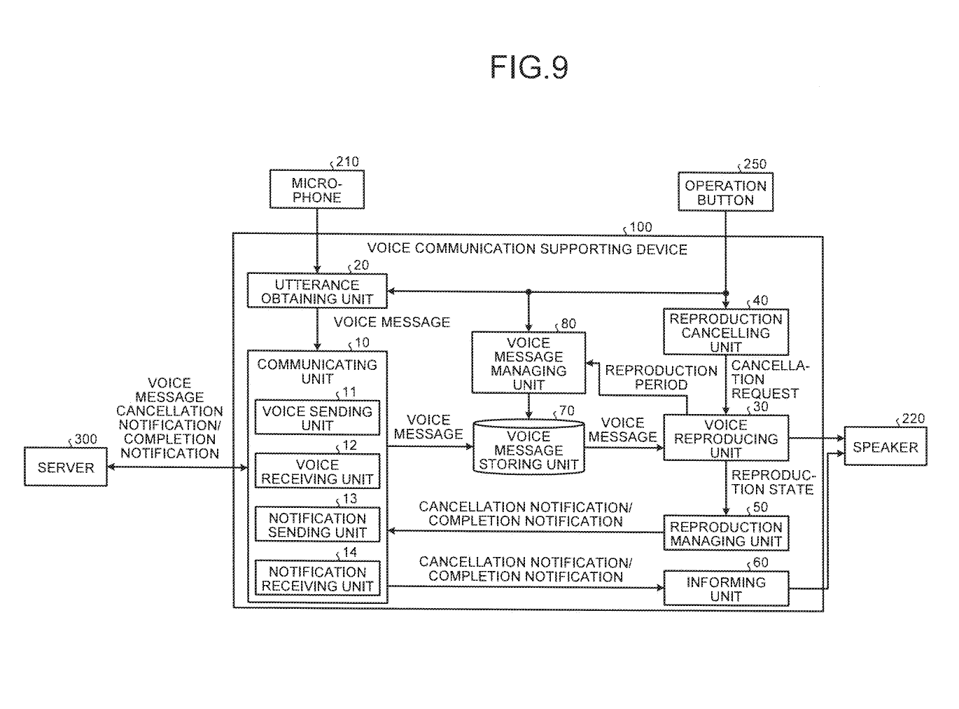

Meanwhile, in the second embodiment, the voice communication supporting device 100 can be configured in such a way that, when the reproduction of a voice message that is reproduced again is completed by the voice reproducing unit 30 without the reproduction getting cancelled, a completion notification about completion of the reproduction of the voice message is sent to the other voice communication supporting device 100 which had sent the concerned voice message. FIG. 9 is a block diagram illustrating such a modification example of the second embodiment. Although the constituent elements are same as in the configuration example illustrated in FIG. 6, the two configurations differ in the following manner: the reproduction managing unit 50 has the function of issuing a completion notification to the notification sending unit 13 in addition to the function of issuing a cancellation notification; the notification sending unit 13 has the function of sending a completion notification in addition to the function of sending a cancellation notification; the notification receiving unit 14 has the function of receiving a completion notification in addition to the function of receiving a cancellation notification; and the informing unit 60 has the function of informing the user about completion of the reproduction of a voice message in addition to the function of informing the user about cancellation of the reproduction of a voice message.

In the modification example, the reproduction managing unit 50 monitors the reproduction state of the voice message that is being reproduced again by the voice reproducing unit 30 (i.e., the voice message whose reproduction has been cancelled once), and determines whether or not the reproduction of the voice message is completed without the reproduction getting cancelled. If the reproduction of the voice message is completed, then the reproduction managing unit 50 issues a completion notification about the completion of reproduction of the voice message to the notification sending unit 13 of the communicating unit 10. Then, the notification sending unit 13 sends the completion notification to the other voice communication supporting device 100, which had sent the voice message, via the server 300, for example.

In the other voice communication supporting device 100 that had sent the voice message, the notification receiving unit 14 receives the completion notification and sends it to the informing unit 60. Upon receiving the completion notification from the notification receiving unit 14, the informing unit 60 performs, for example, a voice output from the speaker 220 and informs the user about completion of the reproduction of the voice message whose reproduction was cancelled once at the receiver side. Thus, when the reproduction of the voice message, whose reproduction was cancelled once at the receiver side, is completed; the user who sent that voice message can get to know about completion of the reproduction. Hence, the user can be spared from unnecessarily taking a measure such as uttering the message again so that a voice message is newly sent.

### Third Embodiment

Given below is the explanation of a third embodiment. In the third embodiment, the explanation is given for a configuration in which, based on additional information that is added to a voice message, it is determined whether or not the reproduction of the voice message is cancellable; and, if it is determined that the reproduction of the voice message is not cancellable, the reproduction of the voice message is not cancelled even if the operation button 250 is pressed during the reproduction.

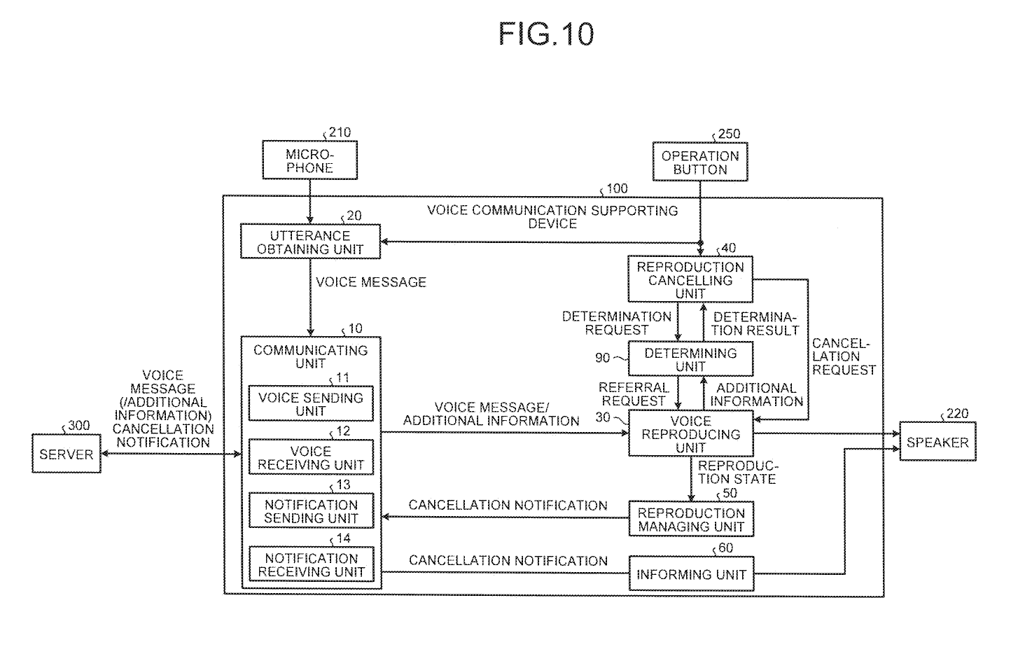

FIG. 10 is a block diagram illustrating a voice communication supporting device 100 according to the third embodiment. As illustrated in FIG. 10, the voice communication supporting device 100 according to the third embodiment includes a determining unit 90 in addition to having the configuration according to the first embodiment (see FIG. 4). The following explanation is given only about the differences with the first embodiment.

In the third embodiment, the voice receiving unit 12 of the communicating unit 10 receives a voice message having additional information added thereto, and sends the voice message to the voice reproducing unit 30. Examples of the additional information include importance degree information indicating the degree of importance of a voice message as determined in the server 300; text information representing the result of voice recognition performed in the server 300; and sender information indicating the sender of a voice message. The importance degree information indicating the degree of importance of a voice message can be added to the voice message in response to a user operation performed by the user who sent the voice message. In that case, at the time of sending an utterance of the user, which is obtained by the utterance obtaining unit 20, as a voice message; the voice sending unit 11 of the communicating unit 10 adds the importance degree information, which indicates the degree of importance set according to a user operation, as additional information to the voice message, and then sends the voice message.

The determining unit 90 is a module that, based on the additional information added to the voice message which is reproduced by the voice reproducing unit 30, determines whether or not the reproduction of the voice message is cancellable. In the third embodiment, if the user presses the operation button 250 while the voice reproducing unit 30 is reproducing a voice message, the reproduction cancelling unit 40 firstly issues a determination request to the determining unit 90 for determining whether or not the reproduction of the voice message is cancellable. Upon receiving a determination request from the reproduction cancelling unit 40, the determining unit 90 issues an additional information referral request to the voice reproducing unit 30 and obtains, in response from the voice reproducing unit 30, the additional information added to the voice message that is being reproduced. Then, the determining unit 90 collates the additional information, which is obtained from the voice reproducing unit 30, with a predetermined rule and determines whether or not the reproduction of the voice message is cancellable.

For example, the predetermined rule can be such that, when the importance degree information represents the additional information added to a voice message, the reproduction of the voice message is cancellable if the degree of importance specified in the importance degree information is lower than a predetermined value. Herein, the predetermined value serving as the threshold value with respect to the degree of importance can be set in advance or can be set according to a user operation.

Alternatively, the rule can be such that, when the text information representing the result of voice recognition represents the additional information added to a voice message, and when a predetermined keyword is included in the text information; the reproduction of the voice message having the text information added thereto is not cancelled. In that case, the predetermined keyword can be set in advance or can be set according to a user operation.

Still alternatively, the rule can be such that, when the sender information represents the additional information added to the voice message, the voice messages sent from particular senders are not cancelled. In that case, the particular senders can be set in advance or can be set according to a user operation.

Meanwhile, the configuration can be such that the rules mentioned above are used in combination and, only if the reproduction of a voice message is determined to be cancellable according to each of those rules, it is determined that the reproduction of the voice message is cancellable.

Subsequently, the determining unit 90 sends the determination result back to the reproduction cancelling unit 40 as a response to the determination request from the reproduction cancelling unit 40. If the determination result received from the determining unit 90 indicates that the reproduction of the voice message is cancellable, the reproduction cancelling unit 40 cancels (stops) the reproduction of the voice message. Then, the subsequent operations according to the third embodiment are performed in an identical manner to the operations performed in the first embodiment.

As described above, in the third embodiment, based on the additional information added to a voice message, it is determined whether or not the reproduction of the voice message is cancellable. If it is determined that the reproduction of a voice message is not cancellable, that voice message is reproduced even if the user performs an operation to cancel the reproduction. Hence, it becomes possible to still more effectively prevent a situation of missing out on listening to the voice messages that need to be listened to. For example, as explained in the first embodiment, when the user on the sender side gets to know from a cancellation notification that the notification of the voice message was cancelled at the receiver side and thus resends a voice message, if the degree of importance of that voice message is set to be high, it can be ensured that the re-sent voice message is reliably reproduced at the receiver side, so that the user on the receiver side reliably listens to the voice message that needs to be listened to.

### Fourth Embodiment

Given below is the explanation of a fourth embodiment. In the fourth embodiment, the explanation is given for a configuration in which a message list screen having a list of received voice messages is displayed, and the reproduction state of each voice message including indication of whether or not the reproduction was cancelled is displayed in an identifiable manner.

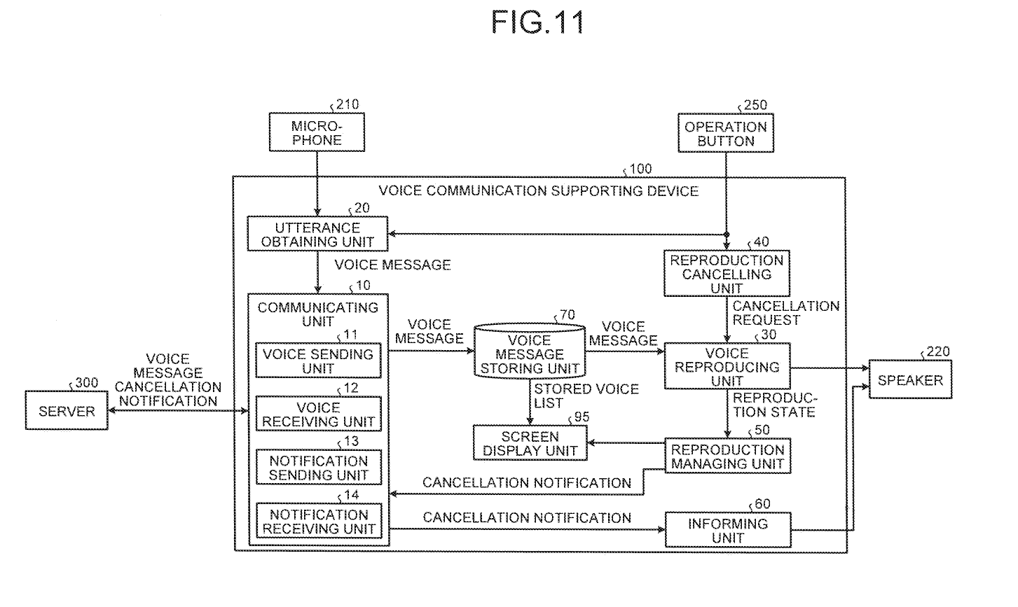

FIG. 11 is a block diagram illustrating a configuration example of the voice communication supporting device 100 according to the fourth embodiment. As illustrated in FIG. 11, the voice communication supporting device 100 according to the fourth embodiment includes the voice message storing unit 70 and a screen display unit 95 in addition to having the configuration according to the first embodiment (see FIG. 4). The following explanation is given only about the differences with the first embodiment.

The voice message storing unit 70 is a voice buffer for storing the voice messages received by the voice receiving unit 12. In the fourth embodiment, in an identical manner to the second embodiment, each voice message stored in the voice message storing unit 70 is sent to the voice reproducing unit 30 as needed, and is reproduced by the voice reproducing unit 30. However, in the second embodiment, a voice message that has been completely reproduced is deleted from the voice message storing unit 70. In contrast, in the fourth embodiment, even the voice messages that have been completely reproduced are not deleted but are kept stored in the voice message storing unit 70. Then, if an acquisition request for a specific voice message is received from the voice reproducing unit 30, the specified voice message is read from the voice message storing unit 70 in response to the acquisition request and is reproduced by the voice reproducing unit 30.

In the fourth embodiment, all voice messages received in the past by the voice communication supporting device 100 are stored in the voice message storing unit 70. However, in the system described earlier, all voice messages that are delivered to the voice communication supporting device 100 are stored in the server 300. Hence, in the case where the voice communication supporting device 100 is used in the system described earlier, the voice communication supporting device 100 need not always store all previously-received voice messages in the voice message storing unit 70. Alternatively, the voice communication supporting device 100 can obtain a previously-received voice message from the server 300 as may be necessary, and use the voice reproducing unit 30 to reproduce the voice message. In that case, instead of using the voice message storing unit 70 to store voice messages, it can be used, for example, to store link information of the storage destinations of the voice messages in the server 300.

The screen display unit 95 is a module that makes use of a display device, such as a touch-sensitive panel display, and displays the message list screen. For example, based on a stored voice list obtained from the voice message storing unit 70 and based on state information obtained from the reproduction managing unit 50, the screen display unit 95 generates a message list screen in which the voice messages received by the voice receiving unit 12 of the communicating unit 10 are listed along with indicating the reproduction state of each voice message in an identifiable manner, and displays the message list screen on the display device such as a touch-sensitive panel display.

In the fourth embodiment, the reproduction state of voice messages is classified into four states, namely, not reproduced, cancelled, being reproduced, and completely reproduced. The voice message storing unit 70 manages the list of voice messages that are currently stored and, when the voice receiving unit 12 receives a new voice message, stores the new voice message, adds the new voice message in the list, and sends a stored voice list having the newly received voice message to the screen display unit 95. Moreover, the reproduction managing unit 50 monitors the reproduction state of the voice message reproduced by the voice reproducing unit 30, and determines the reproduction state of the voice message except for the state of not reproduced. Then, the reproduction managing unit 50 sends the reproduction state of the voice message as state information to the screen display unit 95.

The screen display unit 95 generates a message list screen, in which the voice messages included in the stored voice list obtained from the voice message storing unit 70 are specified in a list form, and displays the message list screen on the display device such as a touch-sensitive panel display. At that time, the screen display unit 95 displays, on the display device such as a touch-sensitive panel display, a message list screen which enables understanding of the fact that the voice messages whose state information is not obtained from the reproduction managing unit 50 have the reproduction state as not reproduced and that the voice messages whose state information is obtained from the reproduction managing unit 50 have the reproduction state corresponding to the state information. Meanwhile, if a large number of voice messages are listed in the stored voice list so that not all voice messages can be fit into the single screen of the message list screen, a predetermined number of voice messages can be sequentially displayed by changing pages on the message list screen.

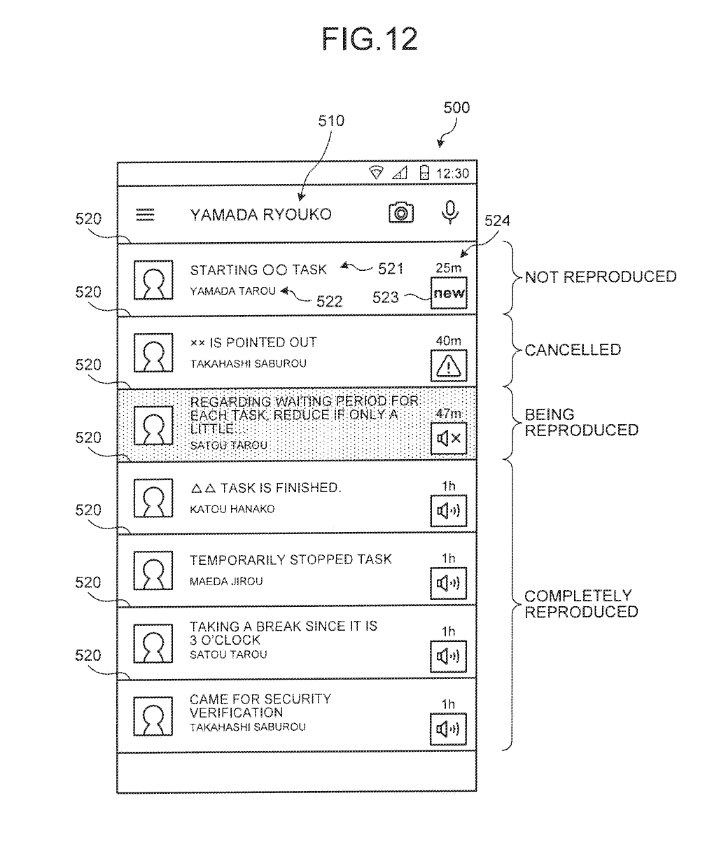

FIG. 12 is a diagram illustrating an example of the message list screen. In a message list screen 500 illustrating in FIG. 12, the voice messages received by the voice receiving unit 12 have the additional information added thereto in the form of text information representing the result of voice recognition performed in the server 300, or in the form of the user names who sent the voice messages, or in the form of distance information representing the distances to the users who sent the voice messages (i.e., the distances between the voice communication supporting devices 100 on the sender side and the voice communication supporting devices 100 on the receiver side).

In the message list screen 500 illustrated in FIG. 12, the screen configuration is such that, below a user information display column 510, a plurality of message items 520 is arranged corresponding to the individually-received voice messages. Each message item 520 includes text information 521 of the corresponding voice message, a sender user name 522 of the corresponding voice message, an icon 523, and time information 524. Each icon 523 has a different display format according to the reproduction state of the corresponding voice message. Thus, the user who refers to the message list screen 500 can check the display format of each icon 523 and understand whether the corresponding voice message is not yet reproduced, or is cancelled from being reproduced, or is being reproduced, or is completely reproduced. The time information 524 indicates the period of time elapsed since the corresponding voice was reproduced. Herein, a voice message that was reproduced within the previous one hour has the time information 524 specified in minutes, while a voice message that was reproduced more than one hour before has the time information 524 specified in hours. Meanwhile, the message item 520 corresponding to the voice message being reproduced has a different format (for example, reversed display) than the other message items 520, so that the user who is listening to the voice message can easily identify the corresponding message item 520.

Moreover, the icon 523 in each message item 520 also serves as a button. Thus, when the user touches the icon 523 in the message item 520 corresponding to a voice message having the reproduction state of either not reproduced, or cancelled, or completely reproduced; the corresponding voice message is reproduced. In contrast, when the user touches the icon 523 in the message item 520 corresponding to the voice message having the reproduction state of being reproduced; the reproduction of the corresponding voice message is cancelled. Meanwhile, the message list screen 500 illustrated in FIG. 12 is only exemplary, and it is not the only possible case. That is, as long as the screen display unit 95 displays a screen of a list of voice messages, which are received from the voice receiving unit 12, in a manner that enables identification of at least whether or not the reproduction of each voice message has been cancelled, it serves the purpose.

As described above, in the fourth embodiment, the screen display unit 95 displays a screen of a list of received voice messages in a manner that enables identification of at least whether or not the reproduction of each voice message has been cancelled. Hence, by referring to the screen, the user can easily identify the voice messages whose reproduction has been cancelled. Therefore, it becomes possible to more effectively prevent a situation of missing out on listening to the voice messages that need to be listened to.

Supplementary Explanation

The various functions of the voice communication supporting device 100 according to the embodiments described above can be implemented by, for example, using the basic hardware of a general-purpose computer system and executing a predetermined application program (software) in the operating system (OS) running in the computer system. In that case, the application program is recorded in a semiconductor memory such as a flash memory or in a recording medium such as an optical/magnetic disk, and is then installed in the voice communication supporting device 100. Alternatively, the application program can be distributed via a network and installed in the voice communication supporting device 100.

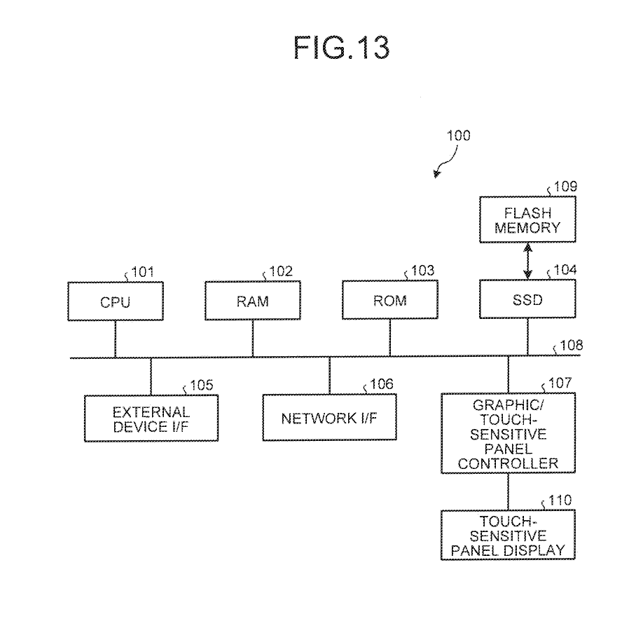

FIG. 13 is a block diagram illustrating an exemplary hardware configuration of the voice communication supporting device 100 according to the embodiments. For example, as illustrated in FIG. 13, in the voice communication supporting device 100; a central processing unit (CPU) 101, a random access memory (RAM) 102, a read only memory (ROM) 103, a solid state drive (SSD) 104, an external device interface (I/F) 105, a network I/F 106, and a graphic/touch-sensitive panel controller 107 are connected to each other by a bus 108. The SSD 104 has a flash memory 109 mounted thereon, and the graphic/touch-sensitive panel controller 107 has a touch-sensitive panel display 110 connected thereto.

In the case of implementing the hardware configuration illustrated in FIG. 13, the application program mentioned above is recorded in, for example, the flash memory 109, and is read from the flash memory 109 by the SSD 104. The CPU 101 uses the RAM 102 as the work area and, while reading necessary data from the ROM 103, executes the application program that is read from the flash memory 109 by the SSD 104. As a result, the functional constituent elements of the voice communication supporting device 100 according to the embodiments are implemented. At that time, the data transmission with the headset 200, which is worn by the user, is performed via the external device I/F 105; while the communication with the server 300 is performed via the network I/F 106. Moreover, the display of information on the touch-sensitive panel display and the reception of button operations on the screen are performed under the control of the graphic/touch-sensitive panel controller 107.

The application program executed in the voice communication supporting device 100 according to the embodiments includes, for example, modules for the functional constituent elements of the voice communication supporting device 100 according to the embodiments. When the CPU 101 executes the application program, the functional constituent elements are loaded and generated in the RAM 102. Meanwhile, the functional constituent elements of the voice communication supporting device 100 according to the embodiments need not be implemented using only the application program (software). Alternatively, some or all of the functional constituent elements can be implemented using a dedicated hardware such as an application specific integrated circuit (ASIC) or a field-programmable gate array (FPGA).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice communication supporting device comprising:
a voice receiving unit configured to receive a voice message;
a voice reproducing unit configured to reproduce the received voice message;
a reproduction cancelling unit configured to, in response to a user operation, perform control to cancel reproduction of the voice message; and
a notification sending unit configured to send, to a sender of the voice message whose reproduction has been cancelled, a cancellation notification about cancellation of reproduction of the voice message.

2. The device according to claim 1, wherein, when reproduction period of the voice message whose reproduction has been cancelled is shorter than a first threshold value, the voice reproducing unit reproduces the voice message, whose reproduction has been cancelled, for second time at a predetermined timing.

3. The device according to claim 2, wherein, when reproduction period of the voice message whose reproduction has been cancelled is shorter than the first threshold value and when an operation button for receiving a user operation is operated repeatedly within a time interval that is shorter than a second threshold value, the voice reproducing unit reproduces the voice message, whose reproduction has been cancelled, for second time at a predetermined timing.

4. The device according to claim 3, further comprising an utterance obtaining unit configured to obtain an utterance of a user, wherein
a user operation for cancelling reproduction of a voice message as well as a user operation for starting to obtain an utterance is received by operation of the operation button.

5. The device according to claim 2, wherein, when reproduction of the voice message that is reproduced for the second time by the voice reproducing unit is completed without cancellation, the notification sending unit further sends, to the sender of the voice message whose reproduction was cancelled, a completion notification about completion of reproduction of the voice message.

6. The device according to claim 1, further comprising a determining unit configured to, based on additional information added to a voice message, determine whether or not reproduction of the voice message is cancellable, wherein when the determining unit determines that the reproduction of the voice message is not cancellable even when a user operation is performed for cancelling reproduction of a voice message, the reproduction cancelling unit does not cancel the reproduction of the voice message.

7. The device according to claim 1, further comprising a screen display unit configured to display a screen of a list of received voice messages in a manner that enables identification of whether or not reproduction was cancelled.

8. The device according to claim 1, further comprising:
an utterance obtaining unit configured to obtain an utterance of a user;
a voice sending unit configured to send the obtained utterance of the user as a voice message to outside;
a notification receiving unit configured to receive the cancellation notification from outside; and
an informing unit configured to, when the cancellation notification is received, notify the user about cancellation of reproduction of the voice message that was sent to outside.

9. The device according to claim 1, wherein the voice reproducing unit reproduces the received voice message regardless of a user operation.

10. A voice communication supporting method implemented in a voice communication supporting device, the method comprising:
receiving a voice message;
reproducing the received voice message;
cancelling reproduction of the voice message in response to a user operation; and
sending, to a sender of the voice message whose reproduction was cancelled, a cancellation notification about cancellation of reproduction of the voice message.

11. A computer program product comprising a computer readable medium including programmed instructions, wherein the programmed instructions, when executed by a computer, cause the computer to perform:
receiving a voice message;
reproducing the received voice message;
cancelling reproduction of the voice message in response to a user operation; and
sending, to a sender of the voice message whose reproduction was cancelled, a cancellation notification about cancellation of reproduction of the voice message.
